(19) United States
(12) Patent Application Publication
(10) Pub. No.: US 2011/0276776 A1
(43) Pub. Date: Nov. 10, 2011

(54) Addressing for Huge Direct-Mapped Object Systems

(75) Inventor: Tatu J. Ylonen, Espoo (FI)

(73) Assignee: TATU YLONEN OY LTD, Espoo (FI)

(21) Appl. No.: 12/775,640

(22) Filed: May 7, 2010

(51) Int. Cl. G06F 12/10; G06F 12/02; G06F 12/00

(52) U.S. Cl. 711/171; 711/203; 711/206; 711/E12.001; 711/E12.002

(57) ABSTRACT

A method, computing system, and computer program product are provided for quickly and space-efficiently mapping an object's address to its home node in a computing system with a very large (possibly multi-petabyte) data set. The addresses of objects comprise three fields: a chunk number, a region sub-index within the chunk, and an offset within the region, with chunks being used to achieve good compromise between small lookup tables and reducing waste of usable virtual address space.

### CROSS-REFERENCE TO RELATED APPLICATIONS

Not Applicable

### INCORPORATION-BY-REFERENCE OF MATERIAL SUBMITTED ON ATTACHED MEDIA

Not Applicable

### TECHNICAL FIELD

The present invention relates to very large distributed and persistent object systems and databases and object systems using distributed shared memory, and to the management of the virtual memory address space therein.

### BACKGROUND OF THE INVENTION

Some distributed and persistent object systems directly use the (64-bit) address of an object as the object's identifier, without necessarily having any other persistent or global identifier for the object. Many of such systems also utilize distributed shared memory for storing and managing the objects, often together with garbage collection.

The address space in such systems is often structured as regions. Regions may be used as the unit of garbage collection, persistence, and/or distribution.

A region is usually a memory area whose size is a power of two, and that starts from an address that is a multiple of its size.

Structuring memory in this way provides an efficient way of finding information about the region based on the address of an object or memory location within the region. The following is an example of computing a region number from its address (“>>” is a right-shift operator, as in the C programming language):

regnum=(addr>>log 2_of_region_size).

More generally, the region number may be computed as:

regnum=((addr−base)>>log 2_of_region_size).

This formulation does not require the “array” of regions to start at a multiple of its size.

In some systems, pointers also contain tag bits that are used to (partially) indicate, e.g., the type of the object, as is known in the art (especially that relating to run-time systems for Lisp and other dynamically typed programming languages). Tag bits may be stored at the least significant bits of the pointer, at the most significant bits of the pointer, or both. A tagged pointer may be converted to a region number using something like

regnum =((addr&mask)>>log 2_of_region_size) or

regnum=(addr>>log 2_of_region_size) & mask2, or

regnum =((addr−base)>>log 2_of_region_size) & mask2.

A known solution for finding the descriptor of a region is to index an array of region descriptors using the region number:

desc=&regions[regnum].

It is also possible in some systems to store information about a region, including its header, at a fixed offset within the region (usually at the beginning). In such case, the region descriptor containing such information may be found using something like:

descaddr=(addr&^{~}(region_size−1)).

However, the latter approach of accessing a region descriptor within the region does not work well in systems where not all regions are always in memory on a particular node (this includes, e.g., many distributed and persistent object systems) or regions may be read/write protected for, e.g., garbage collection or statistics collection purposes.

A distributed system typically comprises many computing nodes, which are computers having one or more processors and hardware-based shared memory, and the term node herein refers to such a computing node within a distributed system. In some systems, the term node may refer to a set of nodes that serve as backups for each other, such that if one node in the set fails, the other nodes in the set can take over its functions and recover its data.

In distributed systems, each region may have an associated home node, and it is frequently necessary to find the home node efficiently from an address (or region number). One possible solution is to store the node identifier in the region descriptor structure. Another possibility is to reserve the same amount of address space for all nodes, such that each node contains the same number of region numbers. In such case, the node number might be computed using something like:

nodenum=regnum>>log 2_regions_per_node or

nodenum=(addr−base)>>(log 2_of_region_size+log 2_of_regions_per_node).

However, in a practical system it is likely that different nodes will have vastly different storage capacities. Some nodes could be able to store petabytes, whereas other nodes would be limited to less than a terabyte.

In supercomputing clusters, a distributed computer may comprise tens of thousands of nodes. If address space is reserved in the petabyte range per node, lots of address space will be wasted, to the degree that even a 64-bit address may become rather tight (especially considering that widely used 64-bit processors today, including the Intel and AMD x86_{—}64 architecture processors, only support 48-bit virtual addresses, of which 47 bits are usable for applications).

Another problem is that most garbage collectors use regions as the smallest unit that can be garbage collected at a time, and typically collect a few regions at a time. Many garbage collectors stop mutators during garbage collection, and in order to keep pauses short, regions must be fairly small, typically in the range of 1 to 4 megabytes.

A petabyte (10̂15 bytes) database divided into 1 megabyte (1̂6) regions means there are 10̂9 regions. A region array describing these regions would become very large. Typically a region descriptor is some tens of bytes, a negligible amount compared to the size of the region. But the region descriptor array might need to be stored on all nodes to quickly locate the home node of a region (and/or which nodes have replicas of the region). At 40 bytes per region, the array of the above example would require 40 gigabytes of main memory, possibly at each node. A 16-petabyte database would correspondingly require 640 gigabytes per node for the array. At present, memory prices are on the order of $40/gigabyte, so in a 10000-node supercomputer with a petabyte of address space, the memory for the descriptor arrays would cost $16 million, more for larger address spaces. Clearly a more efficient solution is needed.

One possible solution is to use a centralized directory for mapping regions to nodes. A centralized server (which could be replicated to a few nodes for redundancy) could be used for storing the directory, and individual nodes could query the directory whenever they need to map a region to a node (and could cache the information for recently mapped regions).

However, a distributed garbage collector might need to make lots of such queries, and when garbage collection is run by many nodes in the same system, such messages could significantly burden the interconnect network, overload the directory, and would significantly slow down any operations that need to know which node some data resides on. A better solution is thus needed.

### BRIEF SUMMARY OF THE INVENTION

The invention provides an advantageous arrangement of virtual memory address space and a method of quickly mapping pointers to memory locations to home nodes for the memory regions containing the memory locations. Methods are also provided for managing the required data structures in a distributed environment.

A first aspect of the invention is a method of mapping a memory address to a node in a computing system, comprising:

dividing part of the address space of the computing system into a plurality of regions, the size of each region in bytes being two raised to an integer power not less than 14, the regions being grouped into chunks, each chunk comprising the same number of regions, the number being two raised to an integer power not less than 5;

constructing, by a processor, a plurality of 64-bit pointers to objects, the pointers comprising a plurality of bits indicating the chunk number and a plurality of bits indicating the sub-index of the region in which the corresponding object resides;

computing, by a processor, a chunk number from a pointer based on the bits therein indicating a chunk number; and

looking up, by a processor, a home node for the memory location identified by the pointer using the chunk number.

A second aspect of the invention is a computing system comprising:

a plurality of nodes, each node comprising at least one processor and a memory, the nodes connected to each other by a network, a plurality of the nodes having a part of their virtual address space divided into a plurality of regions, the size of each region in bytes being two raised to an integer power not less than 14, the regions being grouped into chunks, each chunk comprising the same number of regions, the number being two raised to an integer power not less than 5;

a plurality of 64-bit pointers comprising a plurality of bits indicating a chunk number and a plurality of bits indicating the sub-index of the region in which the corresponding object resides within the corresponding chunk;

an address-to-node mapper configured to compute a chunk number from a pointer based on the bits therein indicating a chunk number and look up a home node for the memory location identified by the pointer from a chunk table using the chunk number.

A third aspect of the invention is a computer program product stored on tangible computer-readable medium comprising computer-readable program code means embodied therein operable to cause a computer to:

divide part of the address space of the computing system into a plurality of regions, the size of each region in bytes being two raised to an integer power not less than 14, the regions being grouped into chunks, each chunk comprising the same number of regions, the number being two raised to a power not less than 5;

construct a plurality of 64-bit pointers to objects, the pointers comprising a plurality of bits indicating the chunk number and a plurality of bits indicating the sub-index of the region in which the corresponding object resides within the corresponding chunk;

compute a chunk number from a pointer based on the bits therein indicating a chunk number; and

look up a home node for the memory location identified by the pointer using the chunk number.

The scope of the invention is specified in the claims, and this brief summary should not be used to limit the invention. Furthermore, the claimed subject matter is not limited to embodiments that solve any or all disadvantages or provide any or all of the benefits noted in any part of this disclosure.

### BRIEF DESCRIPTION OF THE SEVERAL VIEWS OF THE DRAWING(S)

Various embodiments of the invention are illustrated in the drawings.

FIG. 1 illustrates the structure of a pointer (a memory address possibly also including tag bits, usually pointing to the beginning of a corresponding object) in an embodiment of the invention.

FIG. 2 illustrates the layout of the address space in an embodiment.

FIG. 3 illustrates mapping a pointer to a home node in an embodiment.

FIG. 4 illustrates initializing a chunk table in an embodiment.

FIG. 5 illustrates processing an update (delta) received from another node in an embodiment.

FIG. 6 illustrates allocating one or more chunk numbers in an embodiment.

FIG. 7 illustrates message flow in an embodiment while allocating chunk numbers.

FIG. 8 illustrates a computing system embodiment. It also serves as illustrating an embodiment that is a computer program product stored in tangible computer-readable memory.

### DETAILED DESCRIPTION OF THE INVENTION

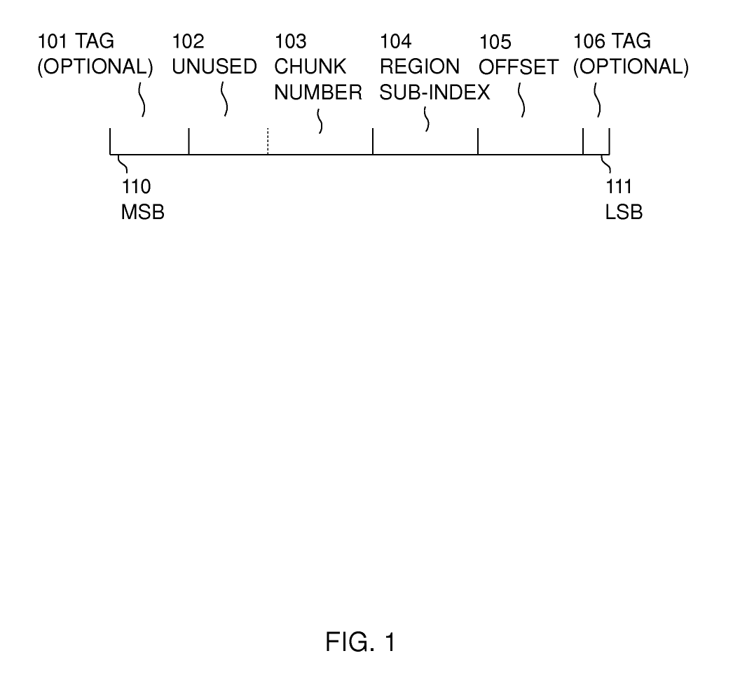

FIG. 1 illustrates the structure of a pointer (memory address) in an embodiment of the invention. The figure illustrates the bits of a 64-bit pointer, with 110 MSB marking most significant bits, and 111 LSB marking least significant bits. 101 and 106 illustrate optional tag bits; 102 unused (usually zero) bits (which may be present on current processors that do not support the full 64-bit address space, and provides an expansion possibility for the future), 103 indicates the chunk number, 104 region sub-index within a chunk, and 105 offset within region (in bytes or words; on most byte-addressed processors, it is advantageous that the tag bits be simply cleared to get an address from the pointer). The chunk number and region sub-index could also be stored in a different order.

Pointers to objects conforming to this layout are constructed by the processor(s), e.g., when objects are allocated (allocation taking place from one of the regions) and/or when computing pointers to within an object (e.g., to a field therein). The chunk number and region sub-index for allocated objects are determined by the region from which space is allocated.

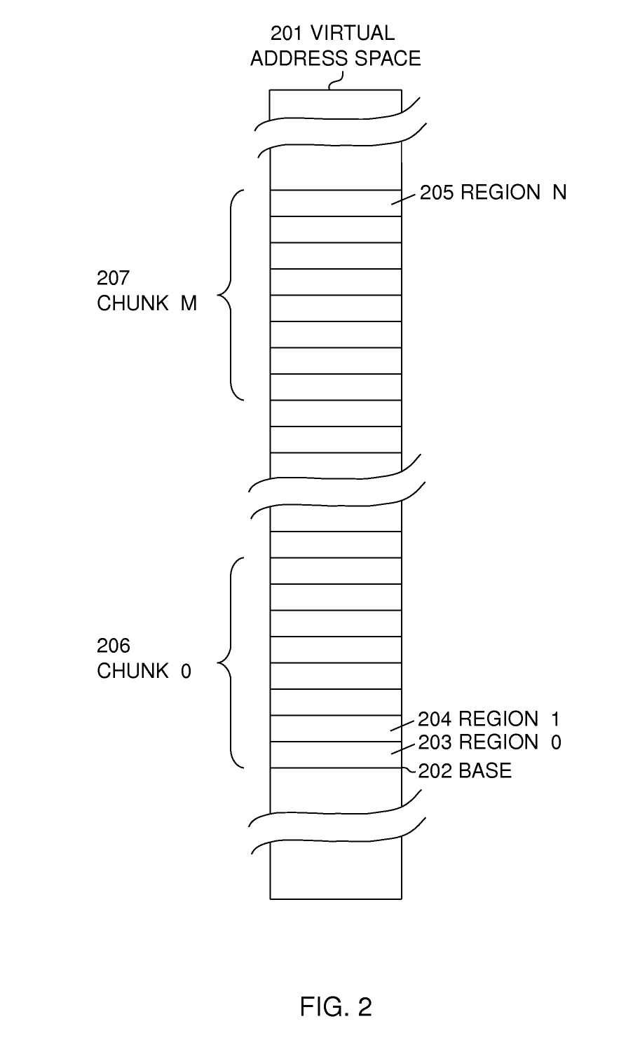

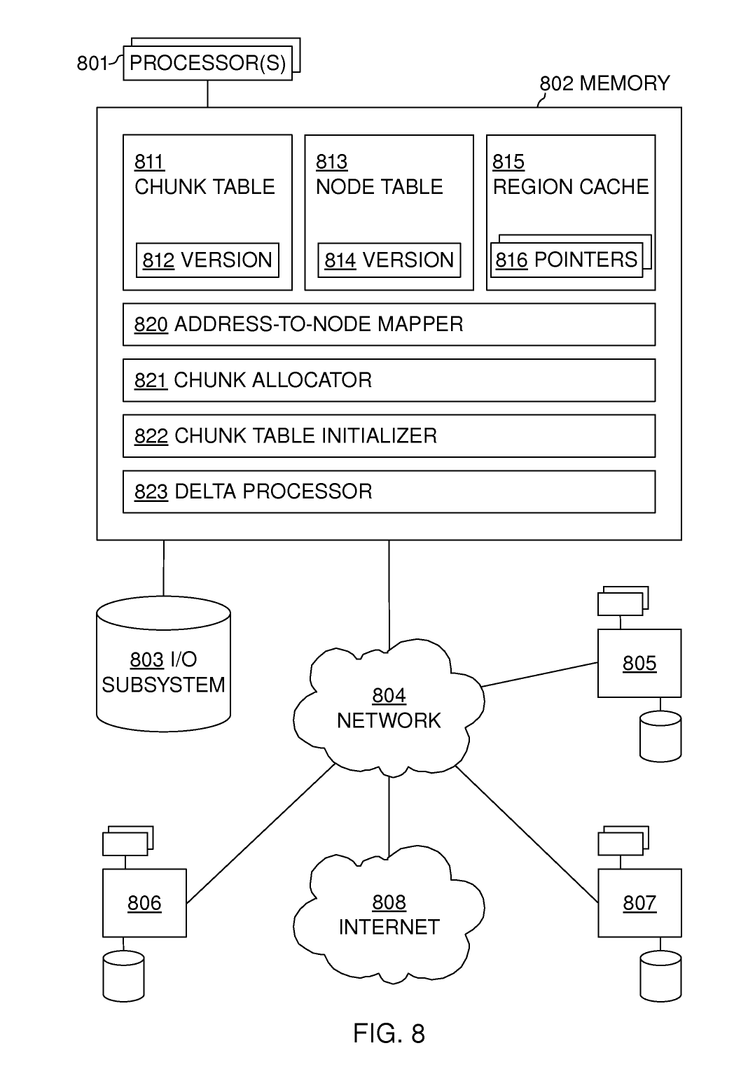

FIG. 2 illustrates the virtual address space in an embodiment. There may also be parts of the virtual address space that are private to each node in the computing system. It is assumed that the illustrated regions be, in principle, accessible to all nodes in the computing system, using, e.g., distributed shared memory (DSM) protocols, but not all nodes necessarily have every region in its memory, and in fact, it is expected that in many embodiments most regions will only exist in non-volatile storage, and only a fraction of regions will be available in working memory at any given time (those regions relate to the region cache 815 in FIG. 8).

The virtual address space may be divided into regions and chunks, e.g., when a computing system or an application program starts. The division may be hard-coded into the logic or program code of the application, may be, e.g., loaded from disk, may be loaded from another node in the computing system, or the division may be performed dynamically.

The virtual address space 201 comprises a plurality of regions (203 illustrating region 0, 204 region 1, 205 region N). The size of each region in bytes is a power of two. Regions may start from address 0 (with the first several regions and/or chunks possibly unused), or may start from a base address 202.

In an embodiment, the regions serve as units of independent garbage collection, and their size is fairly large (typically one to a few megabytes in current garbage collectors, meaning that the exponent is around 20, or at least 14, because with smaller regions the overhead of bookkeeping for garbage collection independence would be excessive). In another embodiment, garbage collection is performed on groups of regions that are not required to be consecutive. The regions in such a group form a collection unit that can be garbage collected independently of other units. In many embodiments there is, however, a relatively small set of regions that must always be garbage collected regardless of what regions or collection units are garbage collected. Typically, the nursery (young object area) is one such area (though the nursery could also be outside normal regions). Such regions that must always be garbage collected typically comprise a small fraction, usually much less than 10%, of all regions in the system that are actually in use. If the fraction was large, it would dilute the benefit from independent garbage collection of regions or other collection units.

Since the address space division produces a large number of potential region and chunk numbers, only a small fraction of them are likely to be actually in use in a particular system, i.e., to have data stored in them and/or have physical memory space reserved for them.

It is highly desirable to be able to garbage collect subsets of the entire virtual address space (individual regions or other collection units). In a stop-the-world collector, this enables garbage collection pauses to be kept short (at the level of tens of milliseconds). Even in concurrent collectors (where mutators run concurrently with the garbage collector), it is important to keep garbage collection cycles reasonably short, so that the nursery memory area(s) can be recycled fairly often, reducing the memory space needed for them (in most garbage collectors, the nursery can be taken for reuse only once per garbage collection cycle). Region-based collection is also desirable when the object graph is partially only on disk.

The regions are divided into a plurality of chunks (206 illustrating chunk 0 and 207 chunk M). Each chunk contains the same number of regions, the number number being a power of two (not all of the region sub-indexes in a chunk are necessarily in use, however). Since the intention is that there be many fewer chunks than regions (so that the chunk table is much smaller than a table indexed by regions would be), each chunk shall contain at least 32 regions (corresponding to an exponent not less than 5). (The figure shows fewer regions per chunk for clarity.)

The size of a chunk is expected to range from a gigabyte to a terabyte or more in many embodiments. For example, a one terabyte chunk would reasonably accommodate modern 2TB disks as the unit in which storage might be added, while keeping the chunk table size reasonable (1024 slots for each petabyte of total storage).

Each home node would typically be a home node for more than one chunk. This enables the chunks to be smaller than the storage space available on typical nodes, while still being large enough to keep the chunk table reasonably small. In fact, it is expected that in many embodiments, some nodes (“storage nodes”) will have much more non-volatile storage than other nodes (“compute nodes”). This structure allows the limited usable virtual address space on current processors to be utilized much more efficiently than would be the case if each node was assigned a fixed number of regions.

Each node typically has private areas in the address space, including those for program code (applications, virtual machines, libraries), malloc-style heap, stacks, and the operating system.

There is no requirement that the chunk number be in more significant bits in the pointer than the region number. If it is, the regions of a chunk may be stored contiguously in virtual memory. If the region sub-index is in higher-order bits, then the regions in a chunk will be scattered in virtual memory, but this is not expected to have a performance impact (except perhaps a minor impact through the operating system's virtual memory implementation).

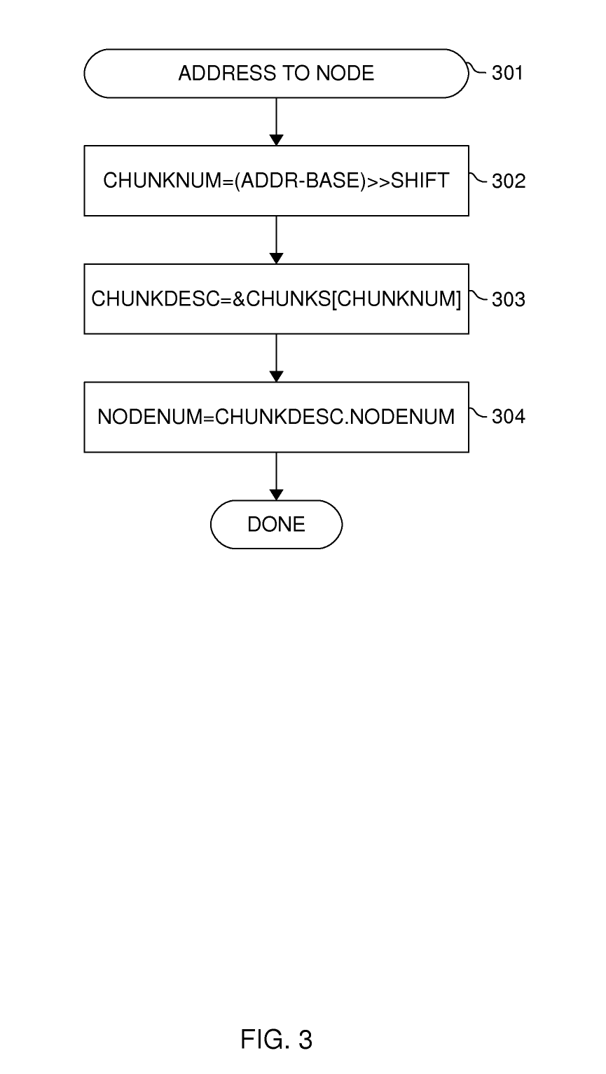

FIG. 3 illustrates mapping a pointer to the corresponding home node. The term “home node” refers to a (logical) node responsible for maintaining an accurate, up-to-date (subject to memory consistency and persistence policy) copy of the region. In some embodiments “home node” may also refer to a set of nodes that act together as a fault-tolerant sub-group, such that data within the fault-tolerant sub-group can be recovered even if one node within the group becomes unavailable.

Mapping an address to a node begins at 301. A chunk number is computed by a processor at 302; the computation may be, for example, any of the following (depending on the embodiment):

chunknum =addr>>shiftcount;

chunknum=(addr−base)>>shiftcount;

chunknum=(addr>>shiftcount)&mask;

chunknum=((addr−base)>>shiftcount)&mask;

chunknum=(addr&mask2)>>shiftcount;

chunknum=((addr−base) & mask2)>>shiftcount;

Here, shiftcount would be the number of bits that the pointer needs to be shifted right to get the chunk number in the least significant bits, and mask is a bit mask having one bits only for the chunk number (in the least significant bits), and zeroes elsewhere (it is used for removing tags). Mask2 is similar, but with the chunk number in its original position in the pointer.

The forms including a mask are advantageous in embodiments where tag bits are used as part of the pointer (especially if tag bits in the most significant bits are used). The forms without a mask are advantageous in most other embodiments. The forms without a base may be advantageous in embodiments where the regions can be allocated starting at fairly low virtual addresses (e.g., after the first terabyte in memory). The forms with a base may be advantageous when, for example, dynamically loaded libraries can be loaded fairly high in memory and there is a need to start the first region at a rather large multiple of the chunk size (in which case there would be very many unused slots at the beginning of the chunk table). It may, however, be possible to simply subtract the first used chunk number times the size of a chunk table slot from the pointer to the chunk table in advance, and index this pointer using a chunk number calculated without subtracting the base, thus entirely avoiding the need to use a base.

Many other ways of computing the chunk number will be understood by one skilled in the art. It is also clear that a unique identifier for regions can be obtained by combining the chunk number and the region sub-index; extracting such a unique identifier from pointers is similar to the above examples for computing the chunk number, with the mask covering both the chunk number and region sub-index fields.

At 303, the chunk number is mapped to a chunk descriptor (basically, this computes the address of the chunk descriptor). The home node is retrieved in 304 (any of, e.g., a node number, fault-tolerant sub-group number, or a pointer to a node descriptor stored in a node table 813 may be retrieved here). Together, 302 and 303 implement looking up the home node by a processor using the chunk number. Indexing the chunk table (chunk information array) is the preferred implementation of 304 because it is expected to be the fastest method (and a relatively small contiguous chunk table can be effectively cached), but, e.g., a hash table could also be used. Clearly, steps 302 and 303 can be merged, and the table slot may also be just a reference to a node table slot (by pointer, number, etc).

Knowing the home node is frequently important, such as in sending various garbage collection related messages (such as a request to update a referring pointer) to the node containing the referring pointer. It is also important in, e.g., distributed shared memory implementations for knowing for which node to queue a fine-granularity update (such operations are needed in the write barrier and/or mutex lock/unlock operations in many distributed shared memory implementations). These operations are sometimes very frequent, and thus it is important that the mapping operation be as fast as possible.

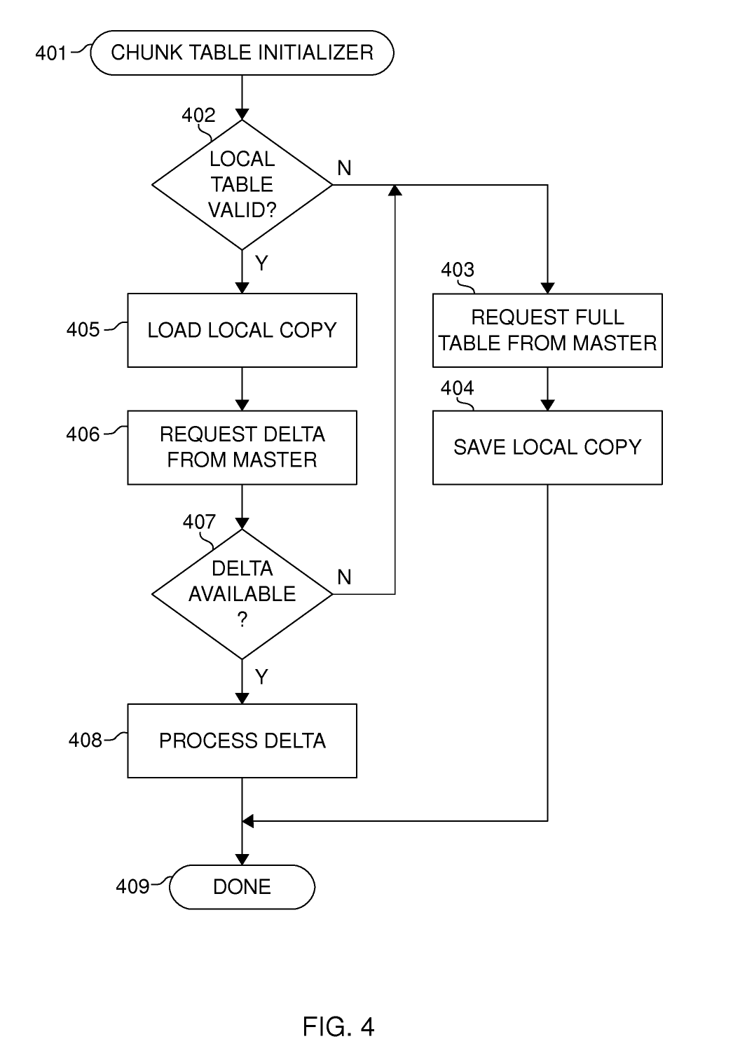

FIG. 4 illustrates initializing the chunk table 401. First, 402 checks whether a local copy of the table (e.g., in local non-volatile storage) is valid. If not, it sends 403 a message to another node in the computing system, preferably a node designated as a master node for managing the chunk table and keeping an authoritative copy of it, waits to receive the copy (resending the request, possibly to a different node, if it timeouts), and saves 404 the received chunk table to local non-volatile storage. If the local table is valid (though not necessarily up to date), it loads 405 the local copy, requests 406 a delta (i.e., set of changes) from a master node, checks 407 if a delta was available (it might not be available if the local copy is so old that the master no longer has a copy of it), and if not, reverts to requesting the full table; otherwise it processes the delta 408, completing the initialization at 409.

The chunk table in this embodiment has a version number 812 that can be used for requesting a delta containing changes occurring after that version.

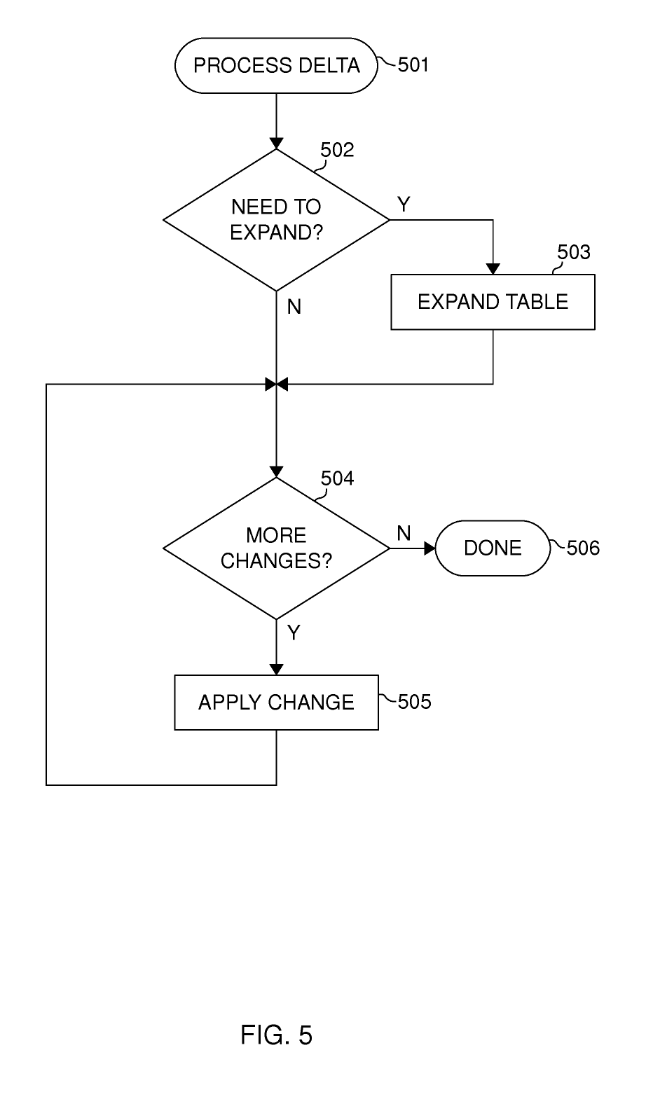

FIG. 5 illustrates processing a delta, i.e., a set of changes to the chunk table, received from another node. Such a delta might be received, e.g., in response to requesting a delta to a particular version of the chunk table, or some node allocating more chunks. A delta might also be sent if the fault-tolerant sub-groups change, if nodes are added, or if new space is added to a node or some region is migrated from one node or fault-tolerant sub-group to another.

Processing the delta begins at 501, and 502 tests whether the chunk table needs to be expanded; if so, 503 expands it. 504 checks if there are more changes, applying 505 one change at a time if there are. 506 terminates the iteration.

Each change to the chunk table may comprise, e.g., the number of the chunk that is modified, and the new home node identifier for the chunk. Applying a change may mean writing the new home node identifier (and possibly other data) to the slot in the chunk table indexed by the chunk number.

A node table (813 in FIG. 8) could be maintained in a similar way.

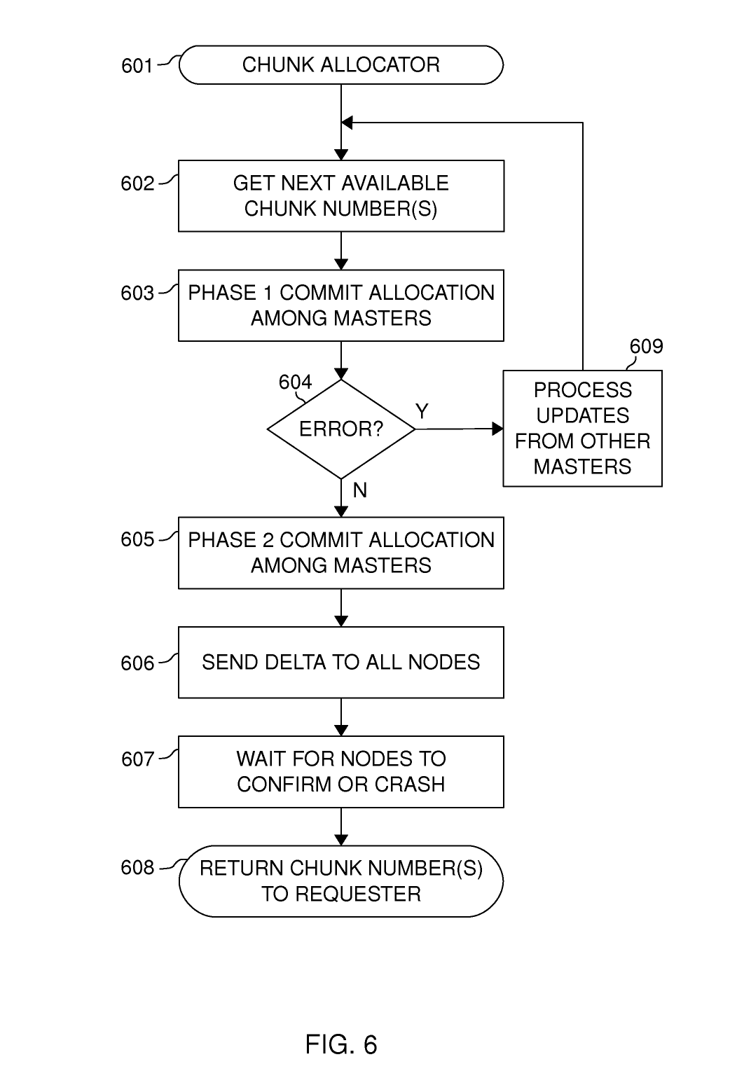

FIG. 6 illustrates a chunk allocator running on a master node, i.e., a node that is responsible for allocating chunk numbers. In most embodiments, a small number of nodes (the master nodes) perform chunk allocation (but other nodes may send requests to the master nodes to allocate new chunks, e.g., when such nodes are made part of the system or more storage space is added to them). A chunk allocation request may be for one or more chunks. It is advantageous to dedicate a subset of all nodes to serve as the master nodes for chunk allocation, because ensuring fault tolerance for the master nodes then becomes easier and the need to store and maintain an authoritative table on every node is avoided.

Chunk allocation starts at 601, typically in response to receiving a message to allocate one or more chunk numbers. The next available chunk number(s) are allocated at 602 (though any available chunk numbers could be allocated).

A phase 1 commit request (of a two-phase commit protocol; such protocols are well known in the field of distributed databases) is then sent 603 to all other master nodes. The phase 1 commit causes each node to check that it has not tried to make conflicting allocations and that it is otherwise able to commit the update. The master nodes then respond to the request. If any node responds with an error to the request 604, then the commit is aborted and updates for the chunk table from other masters are processed 609 (normally such updates will mark any conflicting chunks as allocated), and the allocation is then retried (a limited number of times, which is not shown in the figure).

If all nodes successfully performed phase 1 commit, then it is recorded that the commit was successful and phase 2 commit request is sent to all other master nodes 605. (If nodes reboot or timeout after phase 1 commit, they will later query the originating node about whether the transaction eventually committed or not, and complete the commit then if it was recorded as successful.)

A delta indicating that the region is now allocated and its new home node (normally, the node or the fault-tolerant sub-group from which the allocation request was sent) are sent to other nodes 606. The delta is normally sent to all nodes except the master nodes who already received it as part of the two-phase commit (though re-processing it by them is no problem either, so it may be sent as a reliable broadcast). The requesting node may receive the information as a delta, or as a response to the allocation request.

Then, processing waits for all nodes to acknowledge having processed the delta 607 (otherwise pointers to the new chunk might be seen by nodes before they have learned of its existence). If a node crashes during the delta update, it will get the delta when it requests a delta while initializing its chunk table. Finally, the returned chunk numbers are returned 608 to the original requester, if not already sent in a delta.

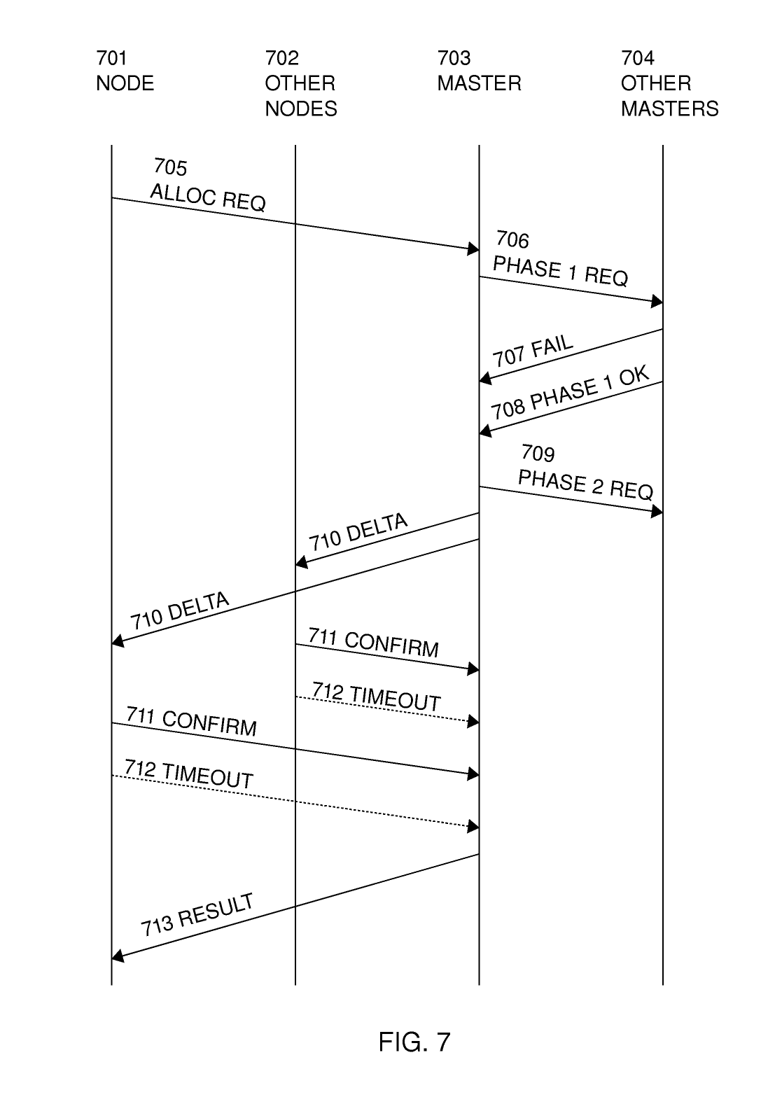

FIG. 7 illustrates message traffic during allocation in an embodiment. 701 illustrates the requesting node, 702 other nodes, 703 the master node performing the allocation, and 704 other master nodes (in the fault-tolerant sub-group of master nodes).

The message 705 is an allocation request sent to a master node. Then, a phase 1 commit request 706 is sent to the other masters. They may respond with a failure 707 or success 708. If successful, a phase 2 request 709 will be sent to the other masters. Then, a delta 710 is sent to the other nodes and to the requesting node. They then confirm having processed the delta 711. A node crashing may be identified from a timeout 712 in receiving its response. Finally, a response indicating that the allocation is complete 713 is sent.

FIG. 8 illustrates a computing system embodiment. It also simultaneously illustrates a computer program product in computer-readable memory 802 comprising various computer-readable program code means 820, 821, 822, 823 as another embodiment.

A node in the computing system comprises one or more processors 801 (which may also be processing cores within a single physical processor chip, ASIC, or system-on-a-chip), main memory 802 (of any fast random-access memory technology, volatile or non-volatile), I/O subsystem 803 (typically comprising non-volatile storage such as disks or solid state disks, and possibly also comprising various other I/O and user interface components), and one or more interfaces to one or more networks 804.

A computing system may comprise one or more nodes. Additional nodes are illustrated by 805, 806, and 807. In some embodiments there could be thousands or tens of thousands of nodes. The network 804 serves as an interconnect between the nodes (it may be, e.g., a 10-gigabit ethernet or an InfiniBand network) and provides a connection to the Internet 808 and/or other external networks (some of which may also be, e.g., radio networks).

In the memory, there are various data structures such as the chunk table 811 (which advantageously also comprises a version number 812) containing information about chunks (e.g., a reference to the corresponding node). Another possible data structure is a node table 813 (which advantageously also comprises a version number 814) containing information about nodes (such as the IP address of the node, an encryption key for communicating it, and information needed for implementing reliable communications with it; it may also contain information for multiple individual nodes implementing a fault-tolerant sub-group). Several slots in the chunk table may refer to the same slot in the node table.

A further data structure is the region cache 815, which comprises information about regions that are currently available in local memory (whether as an authoritative copy or as a replica from another node). It also comprises the actual data for those regions that are available in memory. The objects stored in the regions comprise a plurality of pointers 816 to other objects.

Memory for the regions (for the objects in the regions) is mapped to the virtual address associated with the region. This allows pointers to be used for accessing (reading, modifying) objects in the region cache (i.e., in the regions on the local machine) using normal processor memory access instructions using the pointer as a virtual memory address (possibly after masking away tag bits from it; tag bits in the least significant end may also be removed by adding a displacement to the address, if the exact tag is known at compile time). Being able to use the address directly is very important performance-wise, as it completely eliminates the need for a read barrier (assuming page fault traps are used for paging in/replicating data from disk and other nodes and one is not required by the garbage collector). For writes, depending on the embodiment, a write barrier may be generated by the compiler, but again the need for mapping an object identifier to a memory address is avoided.

The address-to-node mapper 820 is a component for mapping a pointer to the home node of the region that the pointer points to. One possible implementation is illustrated in FIG. 3, and it (and the other components) may be implemented either as a program code means executed by the processor (possibly with the aid of an interpreter or virtual machine) or as digital logic (it is well known in the art how to implement flow charts as state machines in digital logic).

The chunk allocator 821 allocates one or more chunk numbers. One possible implementation is illustrated in FIG. 6.

The chunk table initializer 822 initializes the chunk table on a node. One possible implementation is illustrated in FIG. 4.

The delta processor 823 processes a delta (set of changes) to the chunk table. One possible implementation is illustrated in FIG. 5.

Fault-tolerant sub-groups may be implemented using any method for making a set of computers redundant or fault-tolerant. A fault-tolerant sub-group may be implemented such that logically it looks like a single node, even though it actually is more than one physical node. The physical nodes may act as “hot spares” or “warm spares”. For example, if the sub-group consists of two nodes, the two nodes could have the same amount of storage, and each region for which the sub-group is the home node would be stored on both nodes (similar to mirroring in storage systems). When an update to a region is sent to one of the nodes, it is propagated to the other node before acknowledging it. A read may be satisfied from either node. Other nodes may send requests to either of the nodes, re-sending to the other node if the first one is found to be inoperative.

The number of nodes in a fault-tolerant sub-group is at least two. However, very large sub-groups are disadvantageous, because then maintaining consistency of data among nodes in the group becomes difficult and error-prone (the probability of software bugs becomes higher than the probability of hardware failures). Therefore, the number of nodes in a fault-tolerant sub-groups should be less than 32, normally much less (near two).

Large objects (possibly larger than a single region) may be stored using several contiguous regions. There is no requirement that such contiguous regions would necessarily need to have the same home node. Some region(s) may be reserved for popular objects.

Many variations of the above described embodiments will be available to one skilled in the art. In particular, some operations could be reordered, combined, or interleaved, or executed in parallel, and many of the data structures could be implemented differently. When one element, step, or object is specified, in many cases several elements, steps, or objects could equivalently occur. Steps in flowcharts could be implemented, e.g., as state machine states, logic circuits, or optics in hardware components, as instructions, subprograms, or processes executed by a processor, or a combination of these and other techniques.

It is to be understood that the aspects and embodiments of the invention described in this specification may be used in any combination with each other. Several of the aspects and embodiments may be combined together to form a further embodiment of the invention, and not all features, elements, or characteristics of an embodiment necessarily appear in other embodiments. A method, a computing system, or a computer program product which is an aspect of the invention may comprise any number of the embodiments or elements of the invention described in this specification. Separate references to “an embodiment” or “one embodiment” refer to particular embodiments or classes of embodiments (possibly different embodiments in each case), not necessarily all possible embodiments of the invention. The subject matter described herein is provided by way of illustration only and should not be construed as limiting.

In this specification, selecting has its ordinary meaning, with the extension that selecting from just one alternative means taking that alternative (i.e., the only possible choice), and selecting from no alternatives returns a “no selection” indicator (such as a NULL pointer), triggers an error (e.g., a “throw” in Lisp or “exception” in Java), or returns a default value, as is appropriate in each embodiment.

An object residing in a region means that the object is stored in the region, i.e., in a set of memory locations at least some of which are within the virtual memory address range associated with the region (in many embodiments, only large objects can reside in more than one region, and large objects are usually said to reside in the region where their first memory location is).

A computer may be any general or special purpose computer, workstation, server, laptop, handheld device, smartphone, wearable computer, embedded computer, microchip, or other similar apparatus capable of performing data processing.

A computing system may be a computer, a cluster of computers (possibly comprising many racks or machine rooms of computing nodes and possibly utilizing distributed shared memory), a computing grid, a distributed computer, or an apparatus that performs data processing (e.g., robot, vehicle, vessel, industrial machine, control system, instrument, game, toy, home appliance, or office appliance). It may also be an OEM component or module, such as a natural language interface for a larger system. The functionality described herein might be divided among several such modules.

A computing system may comprise various additional components that a skilled person would know belonging to an apparatus or system for a particular purpose or application in each case. Various examples illustrating the components that typically go in each kind of apparatus can be found in US patents as well as in the open technical literature in the related fields, and are generally known to one skilled in the art or easily found out from public sources.

Computer-readable media can include, e.g., computer-readable magnetic data storage media (e.g., floppies, disk drives, tapes), computer-readable optical data storage media (e.g., disks, tapes, holograms, crystals, strips), semiconductor memories (such as flash memory and various ROM technologies), media accessible through an I/O interface in a computer, media accessible through a network interface in a computer, networked file servers from which at least some of the content can be accessed by another computer, data buffered, cached, or in transit through a computer network, or any other media that can be accessed by a computer.

What is claimed is:

1. A method of mapping a memory address to a node in a computing system, comprising:
dividing part of the address space of the computing system into a plurality of regions, the size of each region in bytes being two raised to an integer power not less than 14, the regions being grouped into chunks, each chunk comprising the same number of regions, the number being two raised to an integer power not less than 5;
constructing, by a processor, a plurality of 64-bit pointers to objects, the pointers comprising a plurality of bits indicating the chunk number and a plurality of bits indicating the sub-index of the region in which the corresponding object resides;
computing, by a processor, a chunk number from a pointer based on the bits therein indicating a chunk number; and
looking up, by a processor, a home node for the memory location identified by the pointer using the chunk number.

2. The method of claim 1, wherein the pointers can be used for accessing objects in the region cache using normal processor memory access instructions using the pointer as a virtual memory address either directly or after masking away tag bits.

3. The method of claim 1, wherein each region is garbage collectible independently of other regions, except for a relatively small set of regions not exceeding 10% of all regions actually in use.

4. The method of claim 1, wherein regions are grouped into collection units without requiring regions in a collection unit to be consecutive, and each collection unit being garbage collectable independently of other collection units, except for a relatively small set of regions not exceeding 10% of all regions actually in use.

5. The method of claim 1, wherein more than one chunk number maps to the same home node.

6. The method of claim 1, wherein the home node refers to more than one but less than 32 nodes that act as a fault-tolerant sub-group, such that data within the fault-tolerant sub-group can be recovered even if one node within the group becomes unavailable.

7. The method of claim 1, wherein the chunk number is computed substantially using a formula selected from the group consisting of:
“chunknum=addr>>shiftcount”;
“chunknum=(addr−base)>>shiftcount”;
“chunknum=(addr>>shiftcount)&mask”;
“chunknum=((addr−base)>>shiftcount)&mask”;
“chunknum=((addr&mask2)>>shiftcount”; and
“chunknum=((addr−base)&mask2)>>shiftcount”.

8. The method of claim 1, wherein the looking up comprises indexing a chunk table by the chunk number.

9. The method of claim 1, further comprising initializing a chunk table, the initializing comprising requesting a full table from another node if the node cannot bring its chunk table up to date based on local information and a delta received from another node.

10. The method of claim 1, further comprising, in at least one node in the computing system:
receiving an allocation request for one or more chunk numbers from another node;
allocating the requested chunk numbers;
performing phase 1 commit within a group of nodes managing chunk numbers as a fault-tolerant sub-group;
upon the phase 1 commit failing on at least one node, repeating the allocating and phase 1 commit steps;
upon the phase 1 commit succeeding, recording that it succeeded and performing phase 2 commit within the group of nodes managing chunk numbers; and
sending a delta to a plurality of nodes to update their chunk tables to reflect that the allocated chunk numbers are associated with the other node.

11. A computing system comprising:
a plurality of nodes, each node comprising at least one processor and a memory, the nodes connected to each other by a network, a plurality of the nodes having a part of their virtual address space divided into a plurality of regions, the size of each region in bytes being two raised to an integer power not less than 14, the regions being grouped into chunks, each chunk comprising the same number of regions, the number being two raised to an integer power not less than 5;
a plurality of 64-bit pointers comprising a plurality of bits indicating a chunk number and a plurality of bits indicating the sub-index of the region in which the corresponding object resides within the corresponding chunk;
an address-to-node mapper configured to compute a chunk number from a pointer based on the bits therein indicating a chunk number and look up a home node for the memory location identified by the pointer from a chunk table using the chunk number.

12. The computing system of claim 11, further comprising a chunk allocator connected to the chunk table configured to allocate chunk numbers and update the chunk table on a plurality of nodes to indicate that the allocated chunk numbers are associated with their new home node.

13. The computing system of claim 11, further comprising a delta processor connected to the chunk table, configured to update the chunk table based on updates received from other nodes.

14. The computing system of claim 11, further comprising a chunk table initializer connected to the chunk table, the initializer configured to initialize the chunk table, in at least one case requesting the chunk table from another node in the computing system.

15. A computer program product stored on tangible computer-readable medium comprising computer-readable program code means embodied therein operable to cause a computer to:
divide part of the address space of the computing system into a plurality of regions, the size of each region in bytes being two raised to an integer power not less than 14, the regions being grouped into chunks, each chunk comprising the same number of regions, the number being two raised to a power not less than 5;
construct a plurality of 64-bit pointers to objects, the pointers comprising a plurality of bits indicating the chunk number and a plurality of bits indicating the sub-index of the region in which the corresponding object resides within the corresponding chunk;
compute a chunk number from a pointer based on the bits therein indicating a chunk number; and
look up a home node for the memory location identified by the pointer using the chunk number.
